(19) United States
(12) Patent Application Publication
(10) Pub. No.: US 2015/0113896 A1
(43) Pub. Date: Apr. 30, 2015

(54) FIRE BLOCK

(71) Applicant: Jeffrey Gordon PAHLMANN, Iberia, MO (US)

(72) Inventor: Jeffrey Gordon PAHLMANN, Iberia, MO (US)

(21) Appl. No.: 14/065,724

(22) Filed: Oct. 29, 2013

(51) Int. Cl. E04B 1/94; A62C 2/06; C09K 21/00

(52) U.S. Cl. CPC E04B 1/941; E04B 1/94; E04B 1/947; C09K 21/00; A62C 2/06
USPC 52/317; 52/741.3

(57) ABSTRACT

A fire block, adapted for blocking flames and air flow from traversing between a first portion of a wall cavity and a second portion of a wall cavity and a method for installing a fire block. The fire block may include a first male tray having a shield with various other components and a female tray having a shield with various components. The male tray be received by the female tray to form a fire block.

### BACKGROUND

Fire blocks may be used in concealed wall cavities. Construction codes often require fire blocks be placed within concealed wall cavities so that in the event of a fire, flames contained in one portion of a wall cavity are slowed from spreading to an adjacent portion of a wall cavity. Fire blocks slow the spreading of flames by physically blocking flames and blocking external sources of air from entering the cavity that would otherwise feed the fire contained therein.

Common practice is to use scrap material from a construction site as a fire block. One type of scrap that is currently used is discarded lumber. Discarded lumber can have old nails, staples, and screws embedded within it that may require removal before implementing it as a fire block. Additionally, use of scrap lumber requires several steps, including: measuring a individual wall cavity space, measuring an individual piece of scrap lumber, marking the individual piece of scrap lumber, cutting the individual piece of scrap lumber, and attaching individual piece of scrap lumber within the wall cavity. These steps must be repeated for each installed scrap lumber fire block and usually must be done by a skilled carpenter. Furthermore, scrap lumber is flammable and susceptible to getting burned away by a fire within a wall cavity.

Some construction codes permit the use of fiberglass insulation as a fire block. Fiberglass insulation fire blocks may be porous and can permit air drafts to enter a blocked wall cavity, thereby providing fuel for a fire contained therein to spread. During construction, insulation fire blocks are often mistakenly removed by subcontractors that do not realize the insulation is meant to serve as a fire block. Furthermore, insulation fire blocks are susceptible to falling or getting blown out of place from within the wall cavity before a front covering of the wall cavity, such as sheetrock, is secured into place.

In construction environments where minimizing fire damage is of the utmost importance, traditional fire blocks may not provide adequate fire blocking. Additionally, in construction environments that require fire blocks to be installed quickly, efficiently, and cheaply, traditional fire blocks may be prohibitively time consuming and expensive to install.

### SUMMARY

A fire block, adapted for blocking flames and air flow from traversing between a first portion of a wall cavity and a second portion of a wall cavity and a method for installing a fire block. In one exemplary embodiment, a fire block may include; a male tray having a male shield with an inner male shield face, an outer male shield face, a first male shield end, a second male shield end, a first male shield rail edge and a second male shield rail edge, at least a first male rail with a first male rail first end and a first male rail second end, and a male ear adapted for coupling the second male shield end to a first cavity side wall of a first stud; and a female tray having a female shield with an inner female shield face, an outer female shield face, a first female shield end, a second female shield end, a first female shield rail edge and a second female shield rail edge, at least a first female rail with a first female rail first end and a first female rail second end, and a female ear adapted for coupling the second female shield end to a second cavity side wall of a second stud; wherein, to form the fire block, the female tray receives the male tray by entering the first male rail first end and at least a first male rail first end portion into the first female rail first end and at least a first female rail first end portion such that at least an outer male shield face first end portion of the outer male shield face is substantially parallel and adjacent to at least an inner female shield face first end portion of the inner female shield face.

In another exemplary embodiment, a method for installing a fire block, adapted for blocking flames and air flow from traversing between a first portion of a wall cavity and a second portion of a wall cavity may include adjusting a male tray within a female tray such that when the fire block is held between, and substantially perpendicular to, a first cavity side wall and a second cavity side wall of a wall cavity, a second male shield end is fitted against the first cavity side wall of a first stud and a second female shield end is fitted against the second cavity side wall of a second stud; holding the adjusted fire block between, and substantially perpendicular to, the first cavity side wall and the second cavity side wall of the wall cavity such that the second male shield end is fitted against the first cavity side wall of the first stud and the second female shield end is fitted against the second cavity side wall of the second stud; and coupling the second male shield end to the first cavity side wall and the second female shield end to the second cavity side wall.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary isometric view of a fire block.

FIG. 2a is an exemplary front view of a female tray of a fire block.

FIG. 2b is an exemplary side view of a female tray of a fire block.

FIG. 2c is an exemplary side view of a male tray of a fire block.

FIG. 2d is an exemplary front view of a male tray of a fire block.

FIG. 2e is an exemplary front view of portion of a female tray of a fire block that includes a second female rail.

FIG. 2f is an exemplary top view of a portion of a male or female tray of a fire block.

FIG. 3a is an exemplary front view of a female tray of a fire block.

FIG. 3b is an exemplary side view of a female tray of a fire block.

FIG. 3c is an exemplary side view of a male tray of a fire block.

FIG. 3d is an exemplary front view of a male tray of a fire block.

FIG. 3e is an exemplary front view of portion of a female tray of a fire block that includes a second female rail.

FIG. 3f is an exemplary top view of a portion of a male or female tray of a fire block.

### DETAILED DESCRIPTION OF THE EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage or mode of operation.

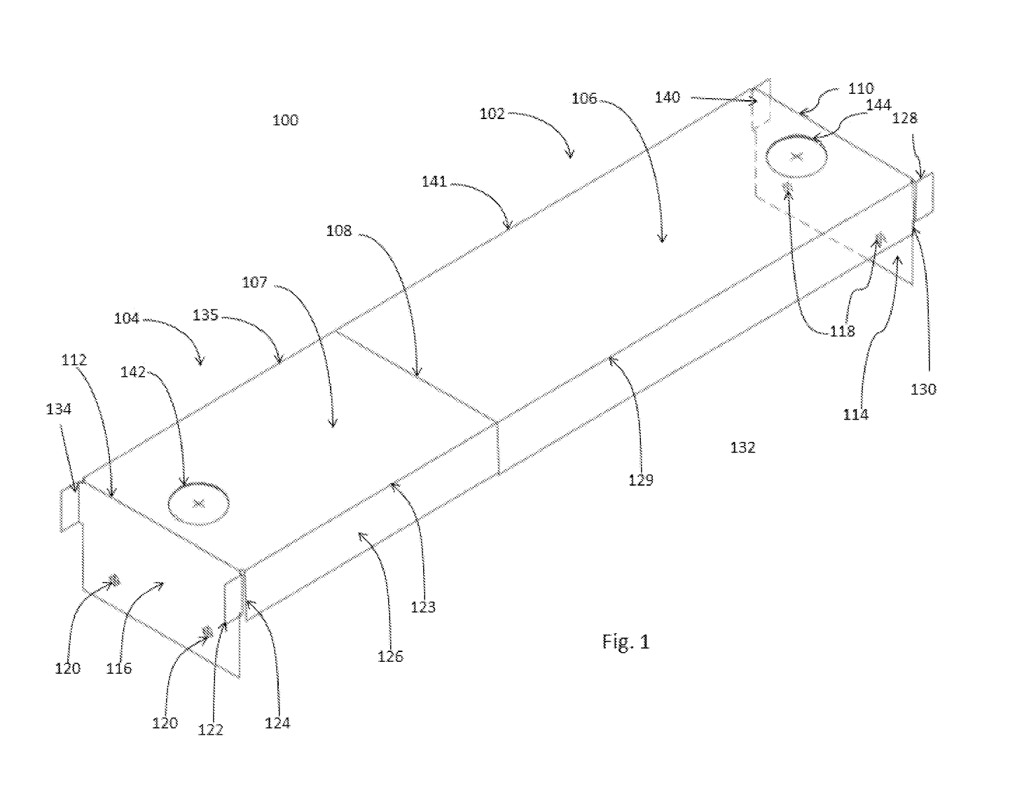

Referring now to FIG. 1, an isometric view of an exemplary embodiment of a fire block 100 may be shown. A fire block 100 may be formed in any of a variety of manners and may be used in any of a variety of situations. Fire block 100 can be made out of fire proof material. Also, fire block 100 may be made out of termite proof material. Additionally, a fire block 100 may be made out of a material that will not rot. For example, fire block 100 can be made out of galvanized metal.

In at least one embodiment, a fire block 100 may be used to block flames from traversing between a first portion of a wall cavity to a second portion of a wall cavity. Also, a fire block 100 may be used to block air that would otherwise feed and enhance an existing fire in a first portion of a wall cavity from traversing from a second portion of a wall cavity into the first portion of the wall cavity. Generally, a fire block 100 can provide exceptional temperature migration, smoke spread, draft, and time of failure performance.

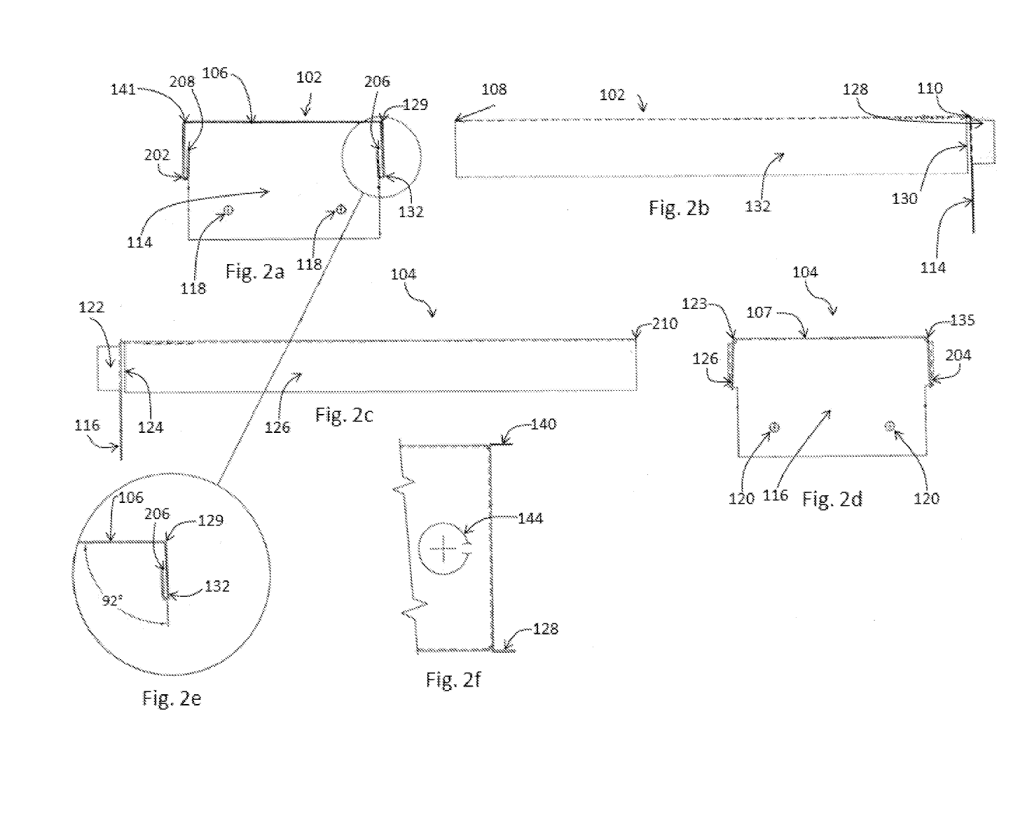

As shown in FIG. 1, the fire block 100 may include a female tray 102 and a male tray 104. The female tray 102 may receive the male tray 104 to form the fire block 100. The portion of the male tray 104 that is received by female tray 102 may be adjustable such that the fire block 100 can be fitted for wall cavities of various widths. The female tray 102 may include a female shield 106 with a first female shield end 108 and a second female shield end 110. The male tray 104 may have a male shield 107 with a first male shield end 210 (see FIG. 2c) and a second male shield end 112. During construction of a building, a fire block 100 may be installed within wall cavities of building that will be concealed once construction of the building is complete. In the event of a fire, the fire block can prevent flames from spreading from one portion of a wall cavity to another portion of a wall cavity, thus limiting the damage caused by the fire.

For example, during construction of a building, a fire block 100 may be installed within a framed wall cavity, such as a stud bay, a joist bay or an attic bay. For the purposes of this application, a “stud” may refer to any member that defines the side walls of a wall cavity. To install a fire block 100 within a wall cavity, the position of the male tray 104 within female tray 102 may be adjusted such that when the fire block 100 is held between and substantially perpendicular to a first cavity side wall and a second cavity side wall of a wall cavity, the second male shield end 112 may fit against the first cavity side wall of a first stud and the second female shield end 110 may fit against the second cavity side wall of a second stud. Once the trays 102, 104 are appropriately adjusted and the fire block 100 is held in proper position, the fire block 100 can be installed by coupling the second male shield end 112 to the first cavity side wall and the second female shield end 110 to the second cavity side wall. Ends 110 and 112 that can be coupled to wall cavity sidewalls can prevent fire block 100 from being mistakenly removed from, falling out of, or getting blown out of place within the wall cavity before a front covering of the wall cavity, such as sheetrock, is secured into place.

Referring again to FIG. 1, the male shield 107 and second male shield end 112 may have a width that is substantially similar to the width of the first cavity side wall. Similarly, the female shield 106 and second female shield end 110 may have a width that is substantially similar to the width of the second cavity side wall. An embodiment of the fire block 100 having female shield 106, second female shield end 110, male shield 107, and second male shield end 112 with widths that are complimentary to the cavity sidewalls can allow the fire block 100 to completely divide a first portion of a wall cavity from a second portion of a wall cavity.

Still referring to FIG. 1, the fire block 100 may include a female ear 114, which may extend from the second female shield end 110. Female ear 114 may extend substantially perpendicularly from the second female shield end 110. Similarly, the fire block 100 may include a male ear 116, which may extend from the second male shield end 112. Male ear 116 may extend substantially perpendicularly from the second male shield end 112. Female ear 114 can be adapted for coupling the second female shield end 110 to a second cavity side wall. Male ear 116 can be adapted for coupling the second male shield end 112 to a first cavity side wall. Ears 114 and 116 can couple shield ends 110 and 112 to cavity side walls by adhesion, for example by glue or tape, or by fastener elements, for example by nails, staples, or screws. Other known methods for coupling in the art may also be employed. Fire block 100 can be adapted to include methods for coupling that can allow a laborer of any skill-level, not necessarily a carpenter, to install fire blocks 100.

As shown in FIG. 1, in some embodiments, female ear 114 may have one or more female ear apertures 118 and male ear 116 may have one or more male ear apertures 120. For example, female ear 114 can have two female apertures 118 and male ear 116 can have two male apertures 120. Male ear apertures 120 can receive one or more fastening elements for coupling the second male shield end 112 to a first cavity side wall. Female ear apertures 118 can receive one or more fastening elements for coupling the second female shield end 110 to a second cavity side wall. In some embodiments, the fastening elements may be driven through apertures 118 and 120 and into cavity side walls by an air powered driver. For example, the fastening elements may be nails that can be driven by an air nailer. Ears 114 and 116 with apertures 118 and 120, respectively, can allow for driving fastening elements with an air powered driver, which an improvement over current fire blocking practice where toenailing of blocks is required. Toenailing of a traditional fire block is difficult and often impossible to perform with an air powered driver. Traditionally, fire blocks are coupled to cavity side walls via toenailing by hand or toenailing with an electric drill. Air powered drivers can allow for quicker and more efficient installation of fire blocks 100 than traditional fire block installation because toenailing is not required and air powered drivers may be used. Additionally, a laborer of any skill-level, not necessarily a carpenter, can install fire blocks 100 because air powered drivers require less skill than toenailing by hand or electric drill. Thus, implementation of fire blocks 100 can reduce labor costs.

Further referring to FIG. 1, male tray 104 may include a first male tab 122 and female tray 102 may include a first female tab 128. The first male tab 122 may be adapted to align the first male rail edge 123 of the male shield 107 with the front side of the first stud when the fire block 100 is held in place within the wall cavity prior to coupling the male ear 116 and the second male shield end 112 to the second cavity sidewall. First male tab 122 may extend substantially perpendicularly from male ear 116. Although not shown, alternatively, in some embodiments, the first male tab 122 may extend from the first male rail second end 124 of a first male rail 126. Similarly, the first female tab 128 may be adapted to align the first female rail edge 129 of the female shield 106 with the front side of the second stud when the fire block 100 is held in place within the wall cavity prior to coupling the female ear 114 and the second female shield end 110 to the second cavity sidewall. First female tab 128 may extend substantially perpendicularly from female ear 114. Although not shown, alternatively, in some embodiments, the first female tab 128 may extend from the first female rail second end 130 of a first female rail 132.

In some embodiments, male tray 104 may include a second male tab 134 and a second male rail, and female tray 102 may include a second female tab 140 and a second female rail. The second male tab 134 may be adapted to align the second male rail edge 135 of the male shield 107 with the back side of the first stud when the fire block 100 is held in place within the wall cavity prior to coupling the male ear 116 and the second male shield end 112 to the second cavity sidewall. Second male tab 134 may extend substantially perpendicularly from male ear 116. Although not shown, alternatively, in some embodiments, the second male tab 134 may extend from the second male rail second end of the second male rail. Similarly, the second female tab 140 may be adapted to align the second female rail edge 141 of the female shield 106 with the back side of the second stud when the fire block 100 is held in place within the wall cavity prior to coupling the female ear 114 and the second female shield end 110 to the second cavity sidewall. Second female tab 140 may extend substantially perpendicularly from female ear 114. Although not shown, alternatively, in some embodiments, the second female tab 140 may extend from the second female rail second end 130 of the second female rail 132. Tabs 122, 128, 134, and 140 can ensure the fire block 100 is properly aligned within the wall cavity. The tabs 122, 128, 134, and 140 can also allow for placing fire block 100 in proper alignment within wall cavity more quickly and efficiently than traditional fire blocks without tabs. The angle between the facial plane of the male ear 116 and the facial plane of the first male tab 122 and second female tab 134 may be substantially a right angle, but slightly larger. For example, the angle between the facial plane of the male ear 116 and the facial plane of the first male tab 122 may be 92 degrees, and the angle between the facial plane of the male ear 116 and the facial plane of the second male tab 134 may be 92 degrees. Similarly, the angle between the facial plane of the female ear 114 and the facial plane of the first female tab 128 and second female tab 140 may be substantially a right angle, but slightly larger. For example, the angle between the facial plane of the female ear 114 and the facial plane of the first female tab 128 may be 92 degrees, and the angle between the facial plane of the female ear 114 and the facial plane of the second female tab 140 may be 92 degrees.

Still referring to FIG. 1, a fire block may have one or more shield apertures, for example a first shield aperture 142 and a second shield aperture 144. Shield apertures 142 and 144 may be adapted to retain elongated members that pass through from the first portion of the wall cavity to the second portion of the wall cavity while the fire block still blocks flames and air flow from traversing between the wall cavity portions. First shield aperture 142 and second shield aperture 144 may be conduit connectors, which may be adapted to retain an electrical conduit that passes through from the first portion of the wall cavity to the second portion of the wall cavity while the fire block 100 still blocks flames and air flow from traversing between the wall cavity portions. In some embodiments, first shield aperture 142 may be disposed within a portion of the male shield 107 that is proximate to the second male shield end 112 and the second shield aperture 144 may be disposed within a portion of the female shield 106 that is proximate to the second female shield end 110. For example, the center of the first shield aperture 142 may be disposed within a portion of the male shield 107 that is 1.0 inch or less from the second male shield end 112 and the center of the second shield aperture may be disposed within a portion of the female shield 106 that is 1.0 inch or less from the second female shield end 110.

Referring now to exemplary FIGS. 2a-f, views of the fire block 100 may be shown. FIG. 2a may be a front view of a female tray 102 of a fire block 100. FIG. 2b may be a side view of a female tray 102 of a fire block 100. FIG. 2c may be a side view of a male tray 104 of a fire block 100. FIG. 2d may be a front view of a male tray 102 of a fire block 100. FIG. 2e may be a front view of portion of a female tray 104 of a fire block 100 that includes a second female rail 202. FIG. 2f may be a top view of a portion of a male or female tray 102, 104 of a fire block 100.

As shown in exemplary FIG. 2a, the first female rail 132 can extend from the first female shield rail edge 129 of the female shield 106. Additionally, a second female rail 202 may extend from the second female shield rail edge 141 of the female shield 106. As shown in FIG. 2d, the first male rail 126 can extend form the first male shield rail edge 123. Additionally, a second male rail 204 can extend from the second male shield edge 135.

Referring back to FIG. 2a, the first female rail 132 may define a first female rail groove 206 into which the first male rail 126 can be received. Likewise, a second female rail 202 may define a second female rail groove 208 into which the second male rail 204 can be received. As shown in FIGS. 2a and 2e, the acute angle between the female shield 106 and the first female rail 132 may be substantially a right angle, but slightly larger. For example, the angle between the female shield 106 and the first female rail 132 may be 92 degrees. The angular relationship between female shield 106 and the second female rail 202 may be the same as the angular relationship between the female shield 106 and the first female rail 132. Similarly, the acute angle between the male shield 107 and the first male rail 126 may be substantially a right angle, but slightly larger. For example, the angle between the male shield 107 and the first male rail 126 may be 92 degrees. The angular relationship between male shield 107 and the second male rail 204 may be the same as the angular relationship between the male shield 107 and the first male rail 126. The angular relationships can ensure the fire block 100 provides a complete divide between a first portion of a wall cavity and a second portion of a wall cavity.

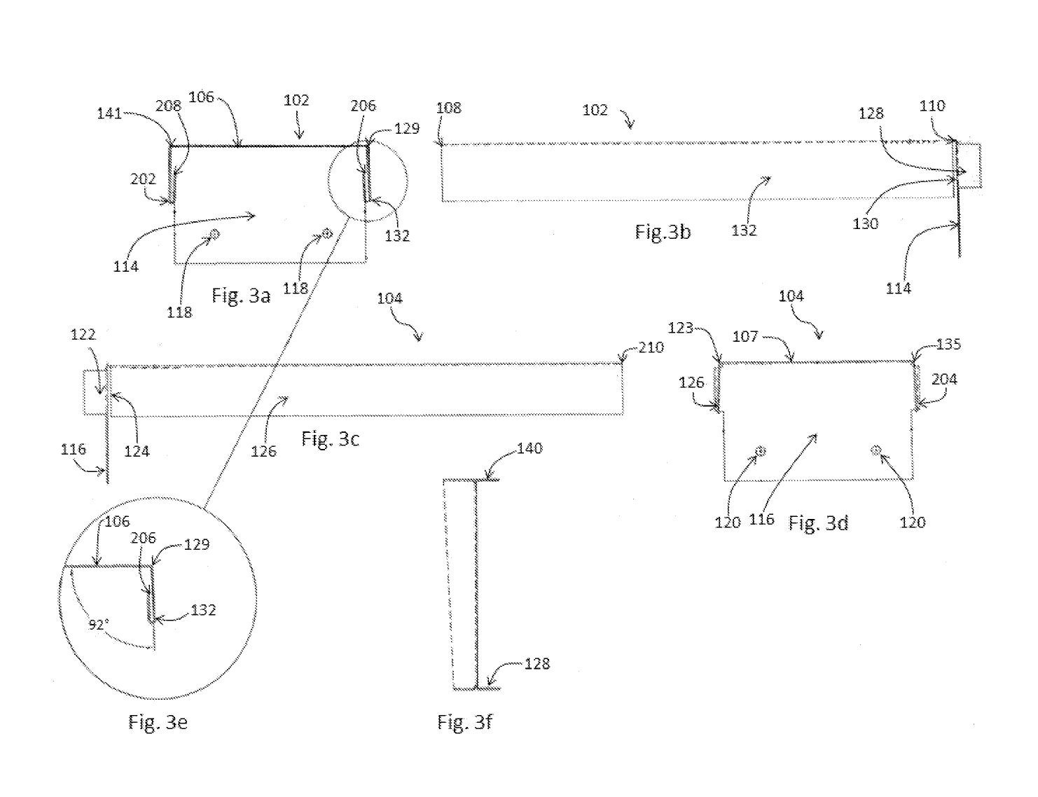

Referring now to exemplary FIGS. 3a-f, views of a fire block 300 may be shown. FIG. 3a may be a front view of a female tray 102 of a fire block 300. FIG. 3b may be a side view of a female tray 102 of a fire block 300. FIG. 3c may be a side view of a male tray 104 of a fire block 300. FIG. 3d may be a front view of a male tray 102 of a fire block 300. FIG. 3e may be a front view of portion of a female tray 104 of a fire block 300 that includes a second female rail 202. FIG. 3f may be a top view of a portion of a male or female tray 102, 104 of a fire block 300.

As shown in exemplary FIG. 3f, a fire block 300 may be shown that does not any shield apertures. Fire block 300 may be used within wall cavities through which no elongated members pass.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A fire block, adapted for blocking flames and air flow from traversing between a first portion of a wall cavity and a second portion of a wall cavity, comprising:
a male tray having a male shield with an inner male shield face, an outer male shield face, a first male shield end, a second male shield end, a first male shield rail edge and a second male shield rail edge, at least a first male rail with a first male rail first end and a first male rail second end, and a male ear adapted for coupling the second male shield end to a first cavity side wall of a first stud;
a female tray having a female shield with an inner female shield face, an outer female shield face, a first female shield end, a second female shield end, a first female shield rail edge and a second female shield rail edge, at least a first female rail with a first female rail first end and a first female rail second end, and a female ear adapted for coupling the second female shield end to a second cavity side wall of a second stud;
wherein, to form the fire block, the female tray receives the male tray by entering the first male rail first end and at least a first male rail first end portion into the first female rail first end and at least a first female rail first end portion such that at least an outer male shield face first end portion of the outer male shield face is substantially parallel and adjacent to at least an inner female shield face first end portion of the inner female shield face.

2. The fire block of claim 1 further comprising:
the male tray having at least a second male rail with a second male rail first end and a second male rail second end; and
the female tray having at least a second female rail with a second female rail first end and a second female rail second end;
wherein, to form the fire block, the female tray adjustably receives the male tray by additionally entering the second male rail first end and at least a second male rail first end portion into the second female rail first end and at least a second female rail first end portion such that at least the outer male shield face first end portion of the outer male shield face is substantially parallel and adjacent to at least the inner female shield face first end portion of the inner female shield face.

3. The fire block of claim 1, further comprising:
the male ear, having at least a first male ear aperture, adapted to receive at least a first male ear fastening element for coupling the second male shield end to the first cavity side wall; and
the female ear, having at least a first female ear aperture, adapted to receive at least a first female ear fastening element for coupling the second female shield end to the second cavity side wall.

4. The fire block of claim 3, further comprising:
the male ear with the first male aperture, adapted to receive the first male ear fastening element that is driven by an air powered driver; and
the female ear with the first female aperture, adapted to receive the first female ear fastening element that is driven by an air powered driver.

5. The fire block of claim 4, wherein the first male ear fastening element and the first female ear fastening element are nails and the air powered driver is an air nailer.

6. The fire block of claim 1, further comprising:
a first male tab, which extends from the first male rail second end, adapted to align the first male shield rail edge with a first stud front side of the first stud when the fire block is held in place within the wall cavity prior to coupling the male ear and the second male shield end to the first cavity side wall of the first stud; and
a first female tab, which extends from the first female rail second end, adapted to align the first female shield rail edge with a second stud front side of the second stud when the fire block is held in place within the wall cavity prior to coupling the female ear and the second female shield end to the second cavity side wall of the second stud.

7. The fire block of claim 2, further comprising:
a first male tab, which extends from the first male rail second end, adapted to align the first male shield rail edge with a first stud front side of the first stud when the fire block is held in place within the wall cavity prior to coupling the male ear and the second male shield end to the first cavity side wall of the first stud;
a second male tab, which extends from the second male rail second end, adapted to align the second male shield rail edge with a first stud back side of the first stud when the fire block is held in place within the wall cavity prior to coupling the male ear and the second male shield end to the first cavity side wall of the first stud;
a first female tab, which extends from the first female rail second end, adapted to align the first female shield rail edge with a second stud front side of the second stud when the fire block is held in place within the wall cavity prior to coupling the female ear and the second female shield end to the second cavity side wall of the second stud.
a second female tab, which extends from the second female rail second end, adapted to align the second female shield rail edge with a second stud back side of the second stud when the fire block is held in place within the wall cavity prior to coupling the female ear and the second female shield end to the second cavity side wall of the second stud.

8. The fire block of claim 1, further comprising:
at least a first shield aperture, adapted to retain elongated members that pass through from the first portion of the wall cavity to the second portion of the wall cavity while the fire block still blocks flames and air flow from traversing between the wall cavity portions.

9. The fire block of claim 8, wherein the at least first shield aperture is a conduit connecter, adapted to retain an electrical conduit that passes through from the first portion of the wall cavity to the second portion of the wall cavity while the fire block still blocks flames and air flow from traversing between the wall cavity portions.

10. The fire block of claim 2, further comprising:
a first shield aperture, adapted to retain elongated members that pass through from the first portion of the wall cavity to the second portion of the wall cavity while the fire block still blocks flames and air flow from traversing between the wall cavity portions; and
at least a second shield aperture, adapted to retain elongated members that pass through from the first portion of the wall cavity to the second portion of the wall cavity while the fire block still blocks flames and air flow from traversing between the wall cavity portions.

11. The fire block of claim 10, wherein the first shield aperture is a first conduit connector and the second shield aperture is a second conduit connector, both of which are adapted to retain an electrical conduit that passes through from the first portion of the wall cavity to the second portion of the wall cavity while the fire block still blocks flames and air flow from traversing between the wall cavity portions.

12. The fire block of claim 11, wherein the first conduit connector is disposed within a portion of the male shield that is proximate to the second male shield end and the second conduit connector is disposed within a portion of the female shield that is proximate to the second female shield end.

13. The fire block of claim 12, wherein a center of the first conduit connector is disposed within a portion of the male shield that is 1.0 inch or less from the second male shield end and a center of the second conduit connector is disposed within a portion of the female shield that is 1.0 inch or less from the second female shield end.

14. The fire block of claim 1, further comprising:
the male shield having a width that is substantially similar to the width of a first cavity side wall of the first stud;
and the second male shield end having a width that is substantially similar to the width of a first cavity side wall of the first stud;
the female shield having a width that is substantially similar to the width of a second stud cavity side wall of the second stud; and
the second female shield end having a width that is substantially similar to the width of a second stud cavity side wall of the second stud.

15. The fire block of claim 2, further comprising:
the male shield having a width that is substantially similar to the width of a first cavity side wall of the first stud;
and the second male shield end having a width that is substantially similar to the width of a first cavity side wall of the first stud;
the female shield having a width that is substantially similar to the width of a second cavity side wall of the second stud; and
the second female shield end having a width that is substantially similar to the width of a second cavity side wall of the second stud.

16. The fire block of claim 1, further comprising the male tray and the female tray that are manufactured out of a fireproof material.

17. The fire block of claim 17, wherein the fireproof material is galvanized metal.

18. The fire block of claim 2, further comprising the male tray and the female tray that are manufactured out of a fireproof material.

19. The fire block of claim 18, wherein the fireproof material is galvanized metal.

20. A method for installing a fire block, adapted for blocking flames and air flow from traversing between a first portion of a wall cavity and a second portion of a wall cavity, comprising:
adjusting a male tray within a female tray such that when the fire block is held between, and substantially perpendicular to, a first cavity side wall and a second cavity side wall of a wall cavity, a second male shield end is fitted against the first cavity side wall of a first stud and a second female shield end is fitted against the second cavity side wall of a second stud;
holding the adjusted fire block between, and substantially perpendicular to, the first cavity side wall and the second cavity side wall of the wall cavity such that the second male shield end is fitted against the first cavity side wall of the first stud and the second female shield end is fitted against the second cavity side wall of the second stud; and
coupling the second male shield end to the first cavity side wall and the second female shield end to the second cavity side wall.
